(19) United States
(12) Patent Application Publication
(10) Pub. No.: US 2020/0401624 A1
(43) Pub. Date: Dec. 24, 2020

(54) COMPACT SCORING INTERFACE

(71) Applicants: Jonathan M. Kopnick, (US); Dante Sarigumba, (US); Stephen Kalayjian, (US); Joseph T. Murphy, (US); Toby Fishman, (US); Doron Fetman, (US)

(72) Inventors: Jonathan M. Kopnick, New York, NY (US); Dante Sarigumba, Monmouth Junction, NJ (US); Stephen Kalayjian, Katonah, NY (US); Joseph T. Murphy, Ridgefield (NY); Toby Fishman, New York, NY (US); Doron J. Fetman, New York, NY (US)

(21) Appl. No.: 16/450,098

(22) Filed: Jun. 24, 2019

(51) Int. Cl. G06F 16/904; G06F 16/901; G06F 16/9038; G06T 11/20

(52) U.S. Cl. CPC G06F 16/904; G06F 16/9024; G06Q 40/00; G06T 11/206; G06F 16/9038

(57) ABSTRACT

A system and method are provided for the compact display of a large amount of customizable input data. A system displays a graphical interface including an overall score and a graphical representation of the overall score. A user may interact with the graphical interface to activate or deactivate one or more subscores that make up the overall score. A user may also interact with the graphical interface to modify how a subscore is calculated. In response to a subscore being activated or deactivated, or to a modification of how a subscore is calculated, the graphical interface updates to reflect the changes. By using the graphical interface, a user can quickly and easily condense data into a single overall score and can view how certain data is affecting the overall score in order to make evaluative decisions.

### BACKGROUND

Data analytics have proliferated across many industries, evaluating people, systems, commodities, assets, products, or opportunities, among other things. Often, data analytics utilize many different calculations or models, all with the goal of discovering useful information that can inform conclusions and support decision-making. It may, however, be difficult to view and absorb the plethora of information that the many different calculations and models provide. In particular, as the mobile devices in use have gotten smaller, for example, laptops, tablets, smart phones, and smart watches, the screen space utilized has gotten smaller with them. Thus, it is even more difficult to view a large amount of data on such a device to make evaluative decisions.

One solution to summarize a large amount of data has been to develop a method that generates and displays a single score from the provided data, such as the method disclosed in U.S. Patent Application Publication No. 2014/0074510, entitled “Personalized Health Score Generator.” Such a method, however, does not provide an interactive approach to readily view how each component of the method is affecting the overall score nor an approach for easily customizing how the overall score is calculated.

### SUMMARY

The present disclosure generally relates to a system and method for the compact display of a large amount of customizable input data. Specifically, a system is provided that displays a graphical interface including an overall score and a graphical representation of the overall score. A user may interact with the graphical interface to activate or deactivate one or more subscores that make up the overall score. A user may also interact with the graphical interface to modify how a subscore is calculated. In response to a subscore being activated or deactivated, or to a modification of how a subscore is calculated, the graphical interface updates to reflect the changes. By using the graphical interface, a user can quickly and easily condense data into a single overall score and can view how certain data is affecting the overall score in order to make evaluative decisions.

In one aspect of the present disclosure, a system is provided that includes a processor, a memory, and a display screen. The display screen is configured to display a graphical interface that includes a first overall aggregate score (OAS) and a graphical representation of the first OAS. The first OAS is generated based on various subscores, and each of the subscores of the various subscores is generated based on a corresponding summarization of source data. Upon interaction with the graphical interface, the display screen is configured to display various graphical representations of each of the various subscores. Interacting with a first graphical representation of a first subscore at least one of activates and deactivates the first subscore. In response to one of activating and deactivating the first subscore, the display screen is configured to recalculate the first OAS and regenerate the graphical representation of the first OAS. The display screen is also configured to update the displayed first OAS and the graphical representation of the first OAS with the recalculated first OAS and regenerated graphical representation of the recalculated first OAS.

In another aspect of the present disclosure, a method includes displaying a graphical interface that includes a first overall aggregate score (OAS) and a graphical representation of the first OAS. The first OAS is generated based on various subscores, and each of the subscores of the various subscores is generated based on a corresponding summarization of source data. The method further includes displaying various graphical representations of each of the various subscores upon interaction with the graphical interface. Interacting with a first graphical representation of a first subscore at least one of activates and deactivates the first subscore. The method further includes recalculating the first OAS and regenerating the graphical representation of the first OAS in response to one of activating and deactivating the first subscore. The method further includes updating the displayed first OAS and the graphical representation of the first OAS with the recalculated first OAS and regenerated graphical representation of the recalculated first OAS.

### BRIEF DESCRIPTION OF THE DRAWINGS

FIG. 1 shows a schematic of a system according to an example of the present disclosure.

FIG. 2 shows a diagram of an interface generator according to an example of the present disclosure.

FIGS. 3A to 3D show example display screens according to aspects of the present disclosure.

FIG. 4 shows a box diagram of an example method for updating a graphical interface in response to activating or deactivating a subscore according to an example of the present disclosure.

FIGS. 5A to 5D show example display screens according to aspects of the present disclosure.

FIG. 6 shows a box diagram of an example method for updating a graphical interface in response to modifying a calculation formula for a subscore according to an example of the present disclosure.

FIGS. 7A to 7C show example diagrams of inputting data to generate an OAS and its respective graphical representation according to an example of the present disclosure.

FIG. 8 shows an example display screen displaying multiple graphical interfaces according to an aspect of the present disclosure.

FIG. 9 shows a diagram of an interface generator according to an example of the present disclosure

FIGS. 10A and 10B show example display screens according to aspects of the present disclosure.

FIG. 11 shows a box diagram of an example method for updating a graphical interface in response to activating or deactivating a subscore according to an example of the present disclosure.

FIG. 12 shows a box diagram of an example method for updating a graphical interface in response to modifying a calculation formula for a subscore according to an example of the present disclosure.

### DETAILED DESCRIPTION

When making evaluative decisions using analytical methods on a large source of data or other information, it can be difficult to keep track of all of the data. It can also be difficult to absorb the meaning behind all of the data as different analytical methods may generate different indications for decision-making. It may also be difficult to compare different analytical methods and absorb how the differences in the methods are affecting the overall outcomes. These difficulties may be amplified when the data is continually updating and thus constantly changing. Accordingly, these difficulties can lead to errors in decision-making based on the data provided. It can also take a lot of time to analyze all of the data, especially if the data is continually updating and the analysis needs to be repeated frequently. When viewing data on the screen of a device, it can also be difficult to view all of the data at once. The amount of data may require switching back and forth from screen to screen, which amplifies the difficulty of absorbing the information because the different data sets may not be compared side by side. This is especially true when the device's screen is small, such as a smartphone screen.

Accordingly, the present disclosure generally relates to a system and method for the compact display of a large amount of customizable input data. Specifically, a system is provided including a display screen configured to display a graphical interface that includes an overall aggregate score (OAS) and a graphical representation of the OAS. The OAS is generated based on various subscores. Changes to the subscores cause both the OAS and the graphical representation of the OAS to update in response to the changes. The subscores themselves are calculated from a source of data based on customizable calculation methods that summarize the data.

The presently disclosed system provides for a quick and simple way to make evaluative decisions of a large amount of data by generating a single score based on customizable calculation methods. By viewing the single generated score, a user may be able to quickly absorb a conclusion for the data based on the analytical calculation methods the user chose. In addition, the presently disclosed system enables a user to easily change the calculation methods for the score, which will cause the score to quickly update. The user can accordingly absorb how changing the calculation method behind the score is affecting the score, and in effect, the evaluative decision. The score that the presently disclosed system provides can also update continuously as the data input to calculate the score changes. Further, the presently disclosed system provides for a simple interface generated on a screen that may be displayed as a single number with a visual representation (i.e., image) that is proportional to the number. A user may quickly understand the meaning behind the score by viewing the number and the visual representation. The interface may also be very small and multiple interfaces may be viewed at a single time on a smartphone screen, or other screen. By utilizing the presently disclosed system, a user may thus absorb a plethora of information by simply viewing and interacting with an interface on the screen of a portable computing device to make accurate, quick evaluative decisions.

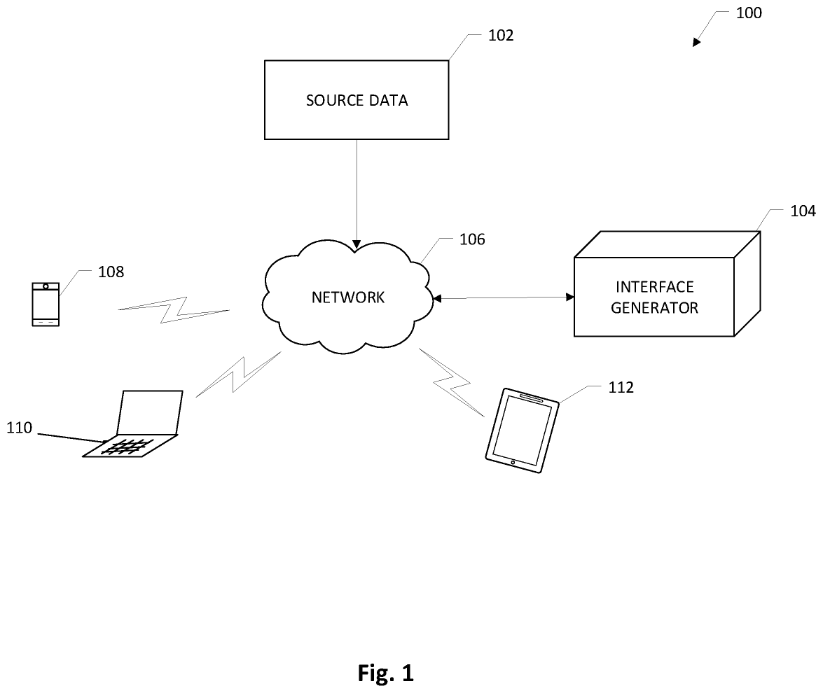

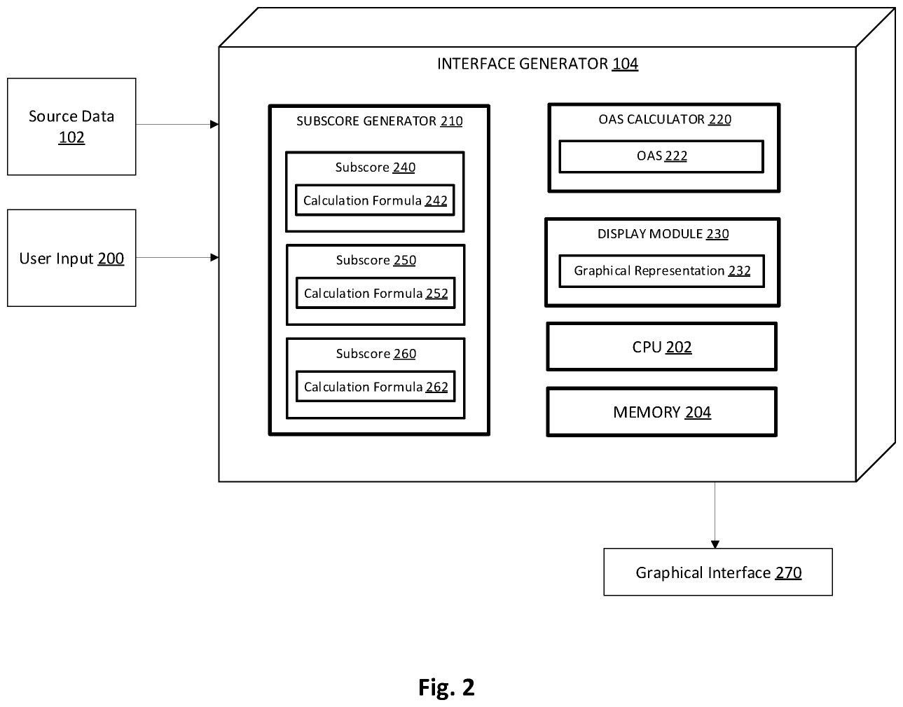

FIG. 1 shows an example system 100 that provides for generating, displaying, and updating a graphical interface, according to one aspect of the present disclosure. Various devices, for example, a smartphone 108, a laptop 110, and a tablet 112, communicate with an interface generator 104 over a network 106, such as the Internet. In other examples, the devices may be other suitable devices capable of communicating with the interface generator 104, for example, a workstation, smart-eyewear, smartwatch, etc. The interface generator 104 also accesses or receives source data 102 over the network 106. For example, the interface generator 104 may continually access source data 102 from a server continually updating data in real-time. In other examples, a user may provide the interface generator 104 with source data 102. In other examples, the source data 102 may be stored historical data and a user may select a certain time period from which to access data. The source data 102 may include any suitable collection of information to be analyzed. The source data 102 may be stored on a server or other suitable data storage device capable of communication over a network (e.g., the network 106). In some examples, the source data 102 may be stored in the memory 204 (FIG. 2) of the interface generator 104 itself and updated as needed.

FIG. 2 shows an example diagram of the interface generator 104 of FIG. 1, according to one aspect of the present disclosure. The interface generator 104 includes different components that are representative of computational processes, routines, and/or algorithms. In some embodiments, the computational processes, routines, and/or algorithms may be specified in one or more instructions stored on a computer readable medium that, when executed by a processor of the interface generator 104, cause the interface generator 104 to perform the operations discussed below. For example, all or part of the computational processes, routines, and/or algorithms may be implemented by the CPU 202 and the memory 204. It should be appreciated that in other embodiments the components of the interface generator 104 may be combined, rearranged, removed, or provided on a separate device or server.

The example interface generator 104 includes a subscore generator 210 that calculates various subscores 240, 250, 260. Each subscore 240, 250, 260 is associated with and based on a calculation formula 242, 252, 262 for calculating the respective subscore 240, 250, 260. Based on input source data 102, the subscore generator 210 may calculate the various subscores 240, 250, 260 according to their respective calculation formulas 242, 252, 262 that summarize the input source data 102. For example, the subscore generator 210 may calculate the subscore 240 from the calculation formula 242, the subscore 250 from the calculation formula 252, and the subscore 260 from the calculation formula 262. In some aspects, one or more subscores 240, 250, 260 may be calculated from the same calculation formula 242, 252, 262. The calculation formulas 242, 252, 262 may be any suitable method of manipulating and analyzing a set of data to output a single value.

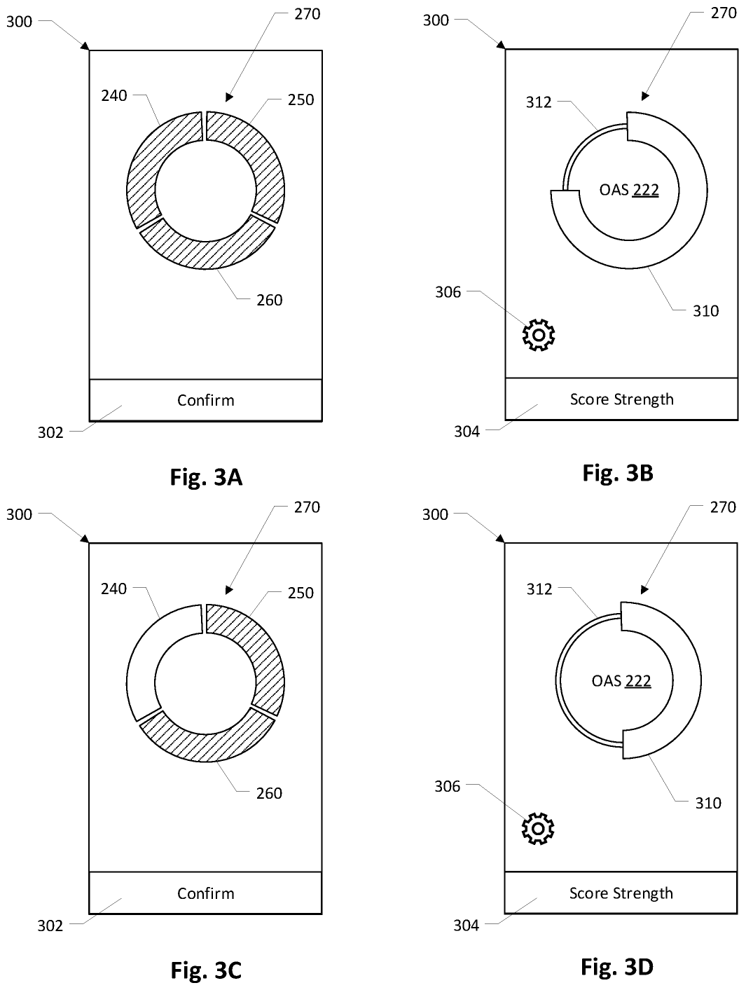

The example interface generator 104 also may include an OAS calculator 220 that may calculate an OAS 222 from the various subscores 240, 250, 260. For example, the OAS calculator 220 may calculate the OAS 222 from the subscore 240, the subscore 250, and the subscore 260. The example interface generator 104 also may include a display module 230 that generates a graphical representation 232 corresponding to the calculated OAS 222 and the calculated subscores 240, 250, 260. For example, the display module 230 may generate a graphical representation 232 corresponding to the OAS 222 and a graphical representation for each of the subscores 240, 250, and 260. The interface generator may then cause an interactive graphical interface 270 to be displayed on a display screen 300 (FIG. 3), the graphical interface 270 including the calculated OAS 222 and the generated graphical representation 232 corresponding to the calculated OAS 222.

In some aspects of the present disclosure, the interface generator 104 may receive a user input 200. For example, the user input 200 may activate or deactivate a subscore 240, 250, 260, or may change the calculation formula 242, 252, 262 of a subscore 240, 250, 260. In such aspects, the OAS calculator 220 may, in response, recalculate the OAS 222 and the display module 230 may regenerate the graphical representation 232. For example, the user input 200 may deactivate the subscore 240, and the OAS calculator 220 may calculate a second OAS 222 from the subscore 250 and the subscore 260, instead of the first OAS 222 calculated from all three subscores 240, 250, and 260. The display module 230 may then generate the graphical representation 232 corresponding to the second OAS 222 and the subscores 250 and 260. The interface generator 104 may then cause the graphical interface 270 to be displayed on the display screen 300 (FIG. 3).

FIGS. 3A to 3D show example diagrams of a display screen 300 displaying a graphical interface 270, according to one aspect of the present disclosure. Throughout this disclosure, the display screen 300 may be installed in a device, such as the smartphone 108, the laptop 110, the tablet 112, or other portable computing device. FIG. 3A shows an example display screen 300 displaying an example graphical interface 270 that includes graphical representations 232 for each of three subscores 240, 250, 260. In some aspects, a graphical interface 270 may be in a ring or circular shape as illustrated in the figures. In other aspects, however, the graphical interface 270 may be in other suitable shapes, for example, a square, triangle, pentagon, octagon, or any other suitable compact shape as will be apparent from the present disclosure. Additionally, in the examples throughout the present disclosure, the dashed lines indicate that the subscores 240, 250, 260 are activated and the absence of dashed lines indicate that the subscores 240, 250, 260 are deactivated. In other examples, any other suitable indication that the subscores 240, 250, 260 are activated or deactivated may be used, for example, different colors, the absence of color, different patterns, bolded font, a check box, etc.

The example display screen 300 also includes a confirm button 302 that a user may select to indicate that an OAS 222 should be calculated based on the subscores 240, 250, 260 that are activated. The confirm button 302 may be displayed in any suitable manner to facilitate a user confirming the settings with which to calculate an OAS 222. In other examples, a display screen 300 may not have a confirm button 302 and a user may indicate that an OAS 222 should be calculated in another suitable manner.

FIG. 3B shows an example display screen 300 displaying a graphical interface 270. For example, the display screen 300 may be configured to display the graphical interface after the user selected the confirm button 302 in FIG. 3A. The example graphical interface 270 includes a graphical representation 232 of an outer bar 310 and an inner bar 312, the graphical representation 232 surrounding an OAS 222. The end of outer bar 310 completes the ring or circular shape (or any shape that the graphical representation 232 takes) proportionally to how the OAS 222 compares to a minimum and maximum score. For example, in some aspects of the present disclosure an OAS 222 may be on a scale of “0-100”. In such aspects, the OAS 222 as illustrated in FIG. 3B would have a value of “75” since the end of the outer bar 310 is illustrated as three-fourths revolved in the clockwise direction. Accordingly, consistent with the illustrated examples, if the OAS 222 were at a maximum value (e.g., 100), then the outer bar 310 would make a complete revolution and no part of the inner bar 312 would be visible on the display screen 300. Conversely, if the OAS 222 were at a minimum value (e.g., 0), then the inner bar 312 would make a complete revolution and no part of the outer bar 310 would be visible on the display screen 300. In other examples, the graphical representation 232 may only have a single outer bar 310 (i.e., an empty space instead of the inner bar 312). In other examples, the outer bar 310 and inner bar 312 may be flipped such that the inner bar 312 is proportional to the OAS 222 instead of the outer bar 310. In other examples, the bar that is proportional to the OAS 222 may revolve in a counter-clockwise direction.

The example display screen 300 in FIG. 3B also includes a score strength banner 304. In some aspects, an OAS 222 may have a “strength” such that a range between a first OAS 222 and a second OAS 222 may correspond to a “strong” score, a different range to a “neutral” score, and a different range to a “weak” score. For example, an OAS 222 of 75-100 may be a “strong” score, of 26-74 may be a “neutral” score, and of 0-25 may be a “weak” score. In such aspects, the score strength banner 304 displays the “strength” of the OAS 222. In other examples, the above ranges may be different or there may be additional ranges with other indicator labels beyond strong, neutral, and weak. Additionally or alternatively, the OAS 222 “strength” may be indicated by a color or pattern on the graphical representation 232 of the graphical interface 270, or by any other suitable indication on the display screen 300 instead of, or in addition to, the score strength banner 304. In some aspects of the present disclosure, the display screen 300 does not include any indication of an OAS 222 “strength” at all.

The example display screen 300 in FIG. 3B also includes a settings button 306 that, when selected, may cause the display screen 300 to display the settings for the OAS 222. The settings button 306, however, is merely for illustrative purposes. In other examples, the display screen 300 may be configured such that the user may access the settings for the OAS 222 in other manners by interacting with the graphical interface 270, for example, by single or double clicking the OAS 222 itself. The settings for the OAS 222 may include a graphical representation 232 of each of the subscores 240, 250, 260 that calculate the OAS 222, whether activated or deactivated. For example, the settings button 306 (or other suitable action in place of the setting button 306 as described) may cause the display screen 300 to show the example display screen 300 of FIG. 3A or of FIG. 3C to the user. From the example display screens 300 in FIG. 3A and FIG. 3C, a user may activate or deactivate a subscore 240, 250, 260.

FIG. 3C shows an example display screen 300 displaying an example graphical interface 270 that includes two activated subscores 250 and 260 and one deactivated subscore 240. For example, a user presented with the display screen 300 in FIG. 3B may have interacted with the setting button 306 or the graphical interface 270 itself to bring the user to display screen 300 illustrated in FIG. 3C, and the user deactivated the subscore 240. In some examples, a user may deactivate or activate a subscore 240, 250, 260 by interacting with the graphical interface 270. For example, a user may select (e.g., press, click, etc.) a graphical representation of a subscore 240, 250, 260 to deactivate or activate it. With the subscore 240 deactivated, once a user selects the confirm button 302, a new OAS 222 and new graphical representation 232 are generated. FIG. 3D shows an example new OAS 222 and new graphical representation 232 as the example graphical interface 270. In this example, deactivating the subscore 240 caused the OAS 222 to decrease to “50” as compared to the example explained in connection with FIG. 3B with an OAS 222 of “75”. For instance, the outer bar 310 in FIG. 3D only makes a half revolution and the inner bar 312 makes the other half revolution. In other examples, activating and/or deactivating one or more subscores 240, 250, 260 may cause the OAS 222 to increase, decrease, or remain the same.

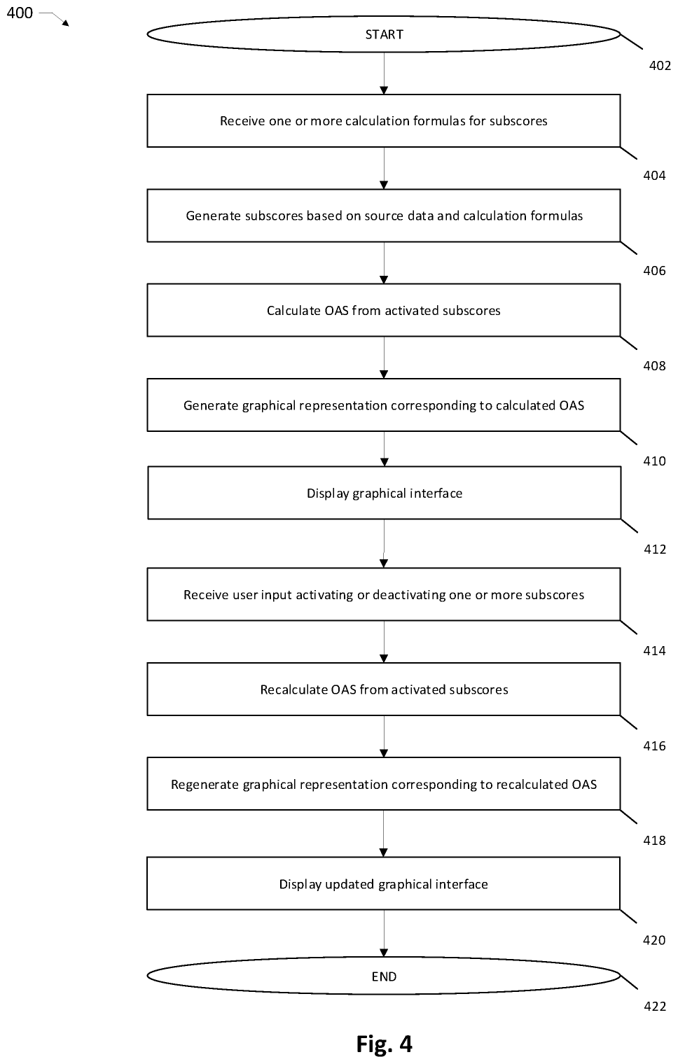

FIG. 4 shows an example method 400 to display a graphical interface 270 that updates in response to activating or deactivating one or more subscores 240, 250, 260, according to an aspect of the present disclosure. The method 400 may be implemented on a computer system, such as the interface generator 104. For example, the method 400 may be implemented by the subscore generator 210, the OAS calculator 220, and/or the display module 230 of the interface generator 104. The method 400 may also be implemented by a set of instructions stored on a computer readable medium that, when executed by a processor, cause the computer system to perform the method. For example, all or part of the method 400 may be implemented by the CPU 202 and the memory 204. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks described may be optional.

In 402, the example method 400 begins. In 404, a system (e.g., the interface generator 104) receives various calculation methods (e.g., the calculation formulas 242, 252, 262) for the various subscores (e.g., the subscores 240, 250, 260). For instance, a user may provide the calculation formulas 242, 252, 262 to the interface generator 104 from a device 108, 110, 112. In other instances, the interface generator 104 may use calculation formulas 242, 252, 262 already stored in its memory 204. For example, a user may create a new calculation formula 242, 252, 262 for a subscore 240, 250, 260 and provide the subscore 240, 250, 260, including its calculation formula 242, 252, 262, to the interface generator 104. In other examples, a user may save a specific subscore 240, 250, 260 that is used for a first OAS 222. The saved subscore 240, 250, 260 may be stored on the user's own device 108, 110, 112 or may be stored in the memory 204 of the interface generator 104. That same user, or a different user, may then access that saved subscore 240, 250, 260 and import it, including its respective calculation formula 242, 252, 262 into a new, second OAS 222. In other examples, a user may save a set of two or more subscores 240, 250, 260 (e.g., the subscores 240, 250, 260 of a first OAS 222). That same user, or a different user, may then access that saved set of subscores 240, 250, 260 and import the set, including their respective calculation formulas 242, 252, 262 into a second OAS 222. The second OAS 222 may include additional subscores 240, 250, 260 beyond the imported set.

In 406, the system (e.g., the interface generator 104) may then access or receive data (e.g., the source data 102) and the system (e.g., the subscore generator 210) may generate various subscores (e.g., subscores 240, 250, 260) based on their respective calculation methods (e.g., calculation formulas 242, 252, 262) and the data (e.g., the source data 102). In 408, the system (e.g., the OAS calculator 220) may then calculate a score (e.g., an OAS 222) from the generated and activated subscores (e.g., subscores 240, 250, 260). In 410, the system (e.g., the display module 230) may generate an image (e.g., a graphical representation 232) corresponding to the generated subscores (e.g., subscores 240, 250, 260) and/or calculated score (e.g., the calculated OAS 222). In 412, the system (e.g., the interface generator 104) may then cause an interface (e.g., the graphical interface 270) to be displayed on a screen (e.g., the display screen 300).

In 414, the example method 400 may then include the system (e.g., the interface generator 104) receiving an input (e.g., the user input 200) activating or deactivating one or more subscores (e.g., subscores 240, 250, 260). In 416, in response to such an input, the system (e.g., the OAS calculator 220) recalculates a new score (e.g., a new OAS 222) from the activated subscores (e.g., the activated subscores 240, 250, 260). In 418, the system (e.g., the display module 230) may then regenerate a new image (e.g., a new graphical representation 232) corresponding to the newly recalculated score (e.g. the recalculated OAS 222). In 420, the system (e.g., the interface generator 104) may then cause the updated interface (e.g., the updated graphical interface 270) to be displayed on the screen (e.g., the display screen 300). At 422, the example method 400 ends.

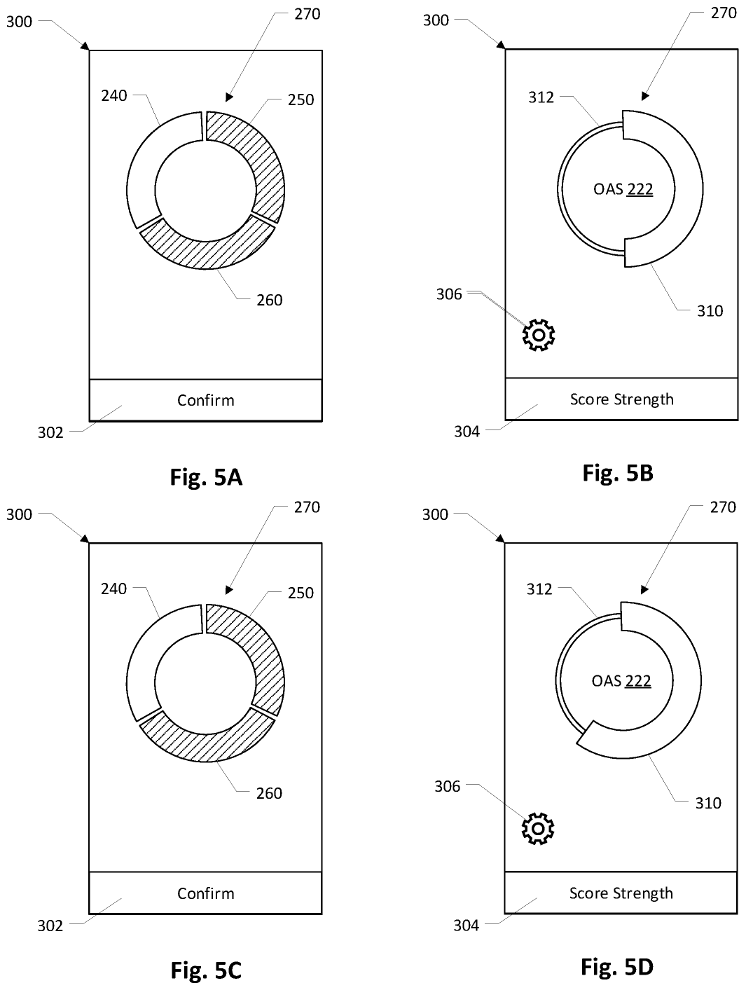

FIGS. 5A to 5D show example diagrams of a display screen 300 displaying a graphical interface 270, according to one aspect of the present disclosure. FIGS. 5A to 5D are similar to the FIGS. 3A to 3D except that instead of illustrating a graphical interface 270 updating in response to a user deactivating a subscore 240, 250, 260, FIGS. 5A to 5D illustrate a graphical interface 270 updating in response to a user changing the calculation formula 242, 252, 262 for a subscore 240, 250, 260. For example, FIG. 5A shows an example display screen 300 with a graphical interface 270 that includes graphical representations 232 for each of the three subscores 240, 250, and 260. The subscore 240 is deactivated. FIG. 5B shows an example display screen 300 with a graphical interface 270 including an OAS 222 and a graphical representation 232 of the OAS 222 with an outer bar 310 and an inner bar 312. The OAS 222 is, for example, a “50” out of a “100” scale given that the outer bar 312 is illustrated as a half revolution, as described in more detail above. The graphical interface 270 in FIG. 5B corresponds to the subscores 240, 250, 260 in FIG. 5A.

A user may select (e.g., press, click etc.) the settings button 302 in FIG. 5B which causes the display screen 300 to display the display screen 300 of FIG. 5C. As described in more detail above, in other examples, the user may execute other actions to get to the settings screen other than the example settings button 302. At the display screen 300 in FIG. 5C, a user may modify the calculation formula 242, 252, 262 of one or more of the subscores 240, 250, 260 by interacting with the graphical interface 270. For example, the user may single or double click the graphical representation 232 of the subscore 250 to cause the display screen 300 to display the calculation formula 242, 252, 262 underlying the subscore 250. The user may then modify the calculation formula 242, 252, 262 and cause the display screen 300 to again display the example display screen 300 of FIG. 5C. The user may then confirm the settings of the subscores 240, 250, 260, for example, by selecting the confirm button 302 (e.g., by pressing or clicking it), and cause the display screen 300 to display an updated graphical interface 270 of a recalculated OAS 222 and its regenerated graphical representation 232, which may appear as they do in FIG. 5D.

In the illustrated example, modifying the calculation formula 242, 252, 262 of the subscore 250 caused the OAS 222 to increase, as is evident by the example outer bar 310 in FIG. 5D making a larger revolution as compared to the outer bar 310 in FIG. 5B. For example, the OAS in FIG. 5D is illustrated as having increased to about “67” out a scale of “100”. In other examples, modifying the calculation formula 242, 25, 262 of one or more subscores 240, 250, 260 may cause the OAS 222 to increase more or less, decrease, or stay the same.

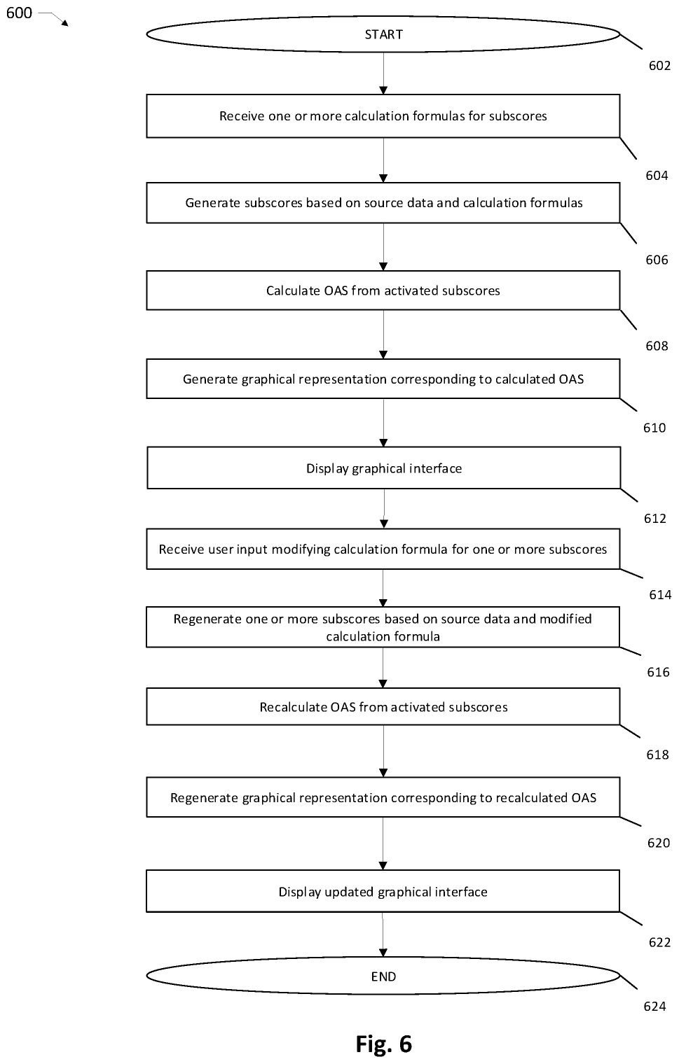

FIG. 6 shows an example method 600 to display a graphical interface 270 that updates in response to modifying the calculation formulas 242, 252, 262 of one or more subscores 240, 250, 260 according to an aspect of the present disclosure. The method 600 may be implemented on a computer system, such as the interface generator 104. For example, the method 600 may be implemented by the subscore generator 210, the OAS calculator 220, and/or the display module 230 of the interface generator 104. The method 600 may also be implemented by a set of instructions stored on a computer readable medium that, when executed by a processor, cause the computer system to perform the method. For example, all or part of the method 600 may be implemented by the CPU 202 and the memory 204. Although the examples below are described with reference to the flowchart illustrated in FIG. 6, many other methods of performing the acts associated with FIG. 6 may be used. For example, the order of some of the blocks may be changed, certain blocks may be combined with other blocks, one or more of the blocks may be repeated, and some of the blocks described may be optional.

In 602, the example method 600 begins. In 604, a system (e.g., the interface generator 104) receives various calculation methods (e.g., the calculation formulas 242, 252, 262) for the various subscores (e.g., the subscores 240, 250, 260). For example, the system (e.g., the interface generator 104) may access or receive the calculation methods (e.g., the calculation formulas 242, 252, 262) in any of the manners described above in connection with the example method 400 and FIG. 4. In 606, the system (e.g., the interface generator 104) may then access or receive data (e.g., the source data 102) and the system (e.g., the subscore generator 210) may generate various subscores (e.g., subscores 240, 250, 260) based on their respective calculation methods (e.g., calculation formulas 242, 252, 262) and the data (e.g., the source data 102). In 608, the system (e.g., the OAS calculator 220) may then calculate a score (e.g., an OAS 222) from the generated and activated subscores (e.g., subscores 240, 250, 260). In 610, the system (e.g., the display module 230) may generate an image (e.g., a graphical representation 232) corresponding to the generated subscores (e.g., subscores 240, 250, 260) and/or calculated score (e.g., the calculated OAS 222). In 612, the system (e.g., the interface generator 104) may then cause an interface (e.g., the graphical interface 270) to be displayed on a screen (e.g., the display screen 300).

In 614, the example method 600 may then include the system (e.g., the interface generator 104) receiving an input (e.g., a user input 200) modifying one or more calculation methods (e.g., the calculation formulas 242, 252, 262) of one or more subscores (e.g., subscores 240, 250, 260). In 616, in response to such an input, the system (e.g., the subscore generator 210) may regenerate one or more subscores (e.g., subscores 240, 250, 260) based on the data (e.g., the source data 102) and the one or more modified calculation methods (e.g., the modified calculation formulas 242, 252, 262). In some examples, the system (e.g., the subscore generator 210) may regenerate all of the subscores (e.g., the subscores 240, 250, 260) regardless of if their calculation method (e.g., a calculation formula 242, 252, 262) was modified. In other examples, the system (e.g., the subscore generator 210) may only regenerate a subscore (e.g., the subscores 242, 252, 262) if its calculation method (e.g., calculation formula 242, 252, 262) was modified. In 618, the system (e.g., the display module 230) may then regenerate a new image (e.g., a new graphical representation 232) corresponding to the newly recalculated score (e.g. the recalculated OAS 222). In 620, the system (e.g., the interface generator 104) may then cause the updated interface (e.g., the updated graphical interface 270) to be displayed on the screen (e.g., the display screen 300). At 622, the example method 600 ends.

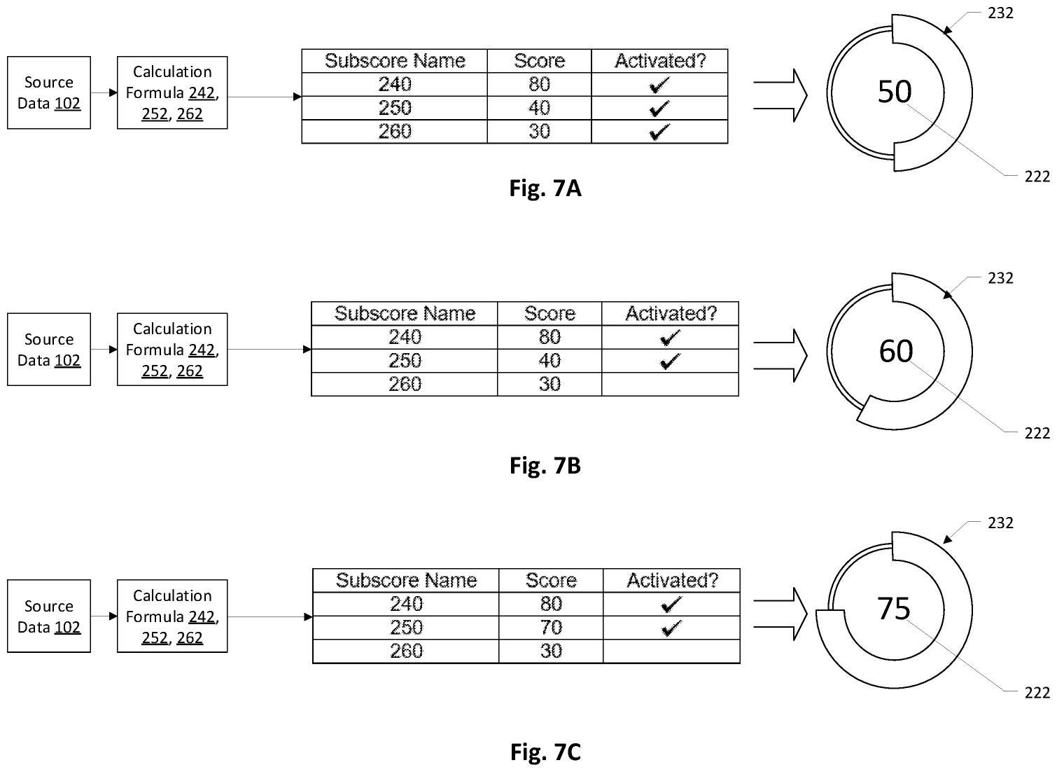

FIGS. 7A to 7C show example inputs of data to calculate an OAS 222 and the effects of both deactivating a subscore 240, 250, 260 and modifying a calculation formula 242, 252, 262. FIG. 7A illustrates source data 102 being input into various calculation formulas 242, 252, 262, which then output various subscores 240, 250, 260. For example, the table in FIG. 7A shows a subscore 240 of “80”, a subscore 250 of “40”, and a subscore 260 of “30”. The table also shows that all three subscores 240, 250, and 260 are activated. The subscores 240, 250, and 260 are then used to calculate an OAS 222, which is represented by a graphical representation 232. In the illustrated example, the OAS 222 of “50” is calculated as the average of the three subscores 240, 250, and 260 (e.g. (80+40+30)/3=50). In other examples, the OAS 222 may be calculated from the subscores 240, 250, 260 using any suitable calculation method. In at least one example, each of the various subscores 240, 250, 260 may be assigned a weight and thus certain subscores 240, 250, 260 may have more of an impact on determining the OAS 222. For instance, each subscore 240, 250, 260 may be multiplied by a percentage out of “100” (e.g., 40%) to get a product and each product may be added together to get a sum. The sum may then be divided by “100” to get the OAS 222. In this instance, the percentages applied to the subscores 240, 250, 260 must add to “100”. In some aspects, an OAS 222 may start at “50” and its subscores 240, 250, 260 may cause the OAS 222 to increase or decrease based on the percentage each subscore 240, 250, 260 is set at.

FIG. 7B illustrates an example recalculation of the OAS 222 when a subscore 240, 250, 260 is deactivated. For instance, the table in FIG. 7B shows that the subscore 260 is deactivated. Accordingly, the OAS 222 is now calculated from only subscore 240 and 250 and is calculated as “60” (i.e., (80+40)/2=60). In this instance, deactivating the subscore 260 caused the OAS 222 to increase and the graphical representation 232 to be regenerated accordingly. FIG. 7C illustrates an example recalculation of the OAS 222 when a calculation formula 242, 252, 262 of a subscore 240, 250, 260 is modified. For instance, the table in FIG. 7C shows that subscore 260 is still deactivated, but that subscore 250 is now “70” instead of “40”. In this instance, the subscore 250 changed because its calculation formula 242, 252, 262 was modified. In other instances, however, the subscore 250, additionally or alternatively, may have changed due to changing source data 102. In the illustrated example, the change in subscore 250 caused the OAS 222 to increase to “75” (i.e., (80+70)/2=75) and the graphical representation 232 to be regenerated accordingly.

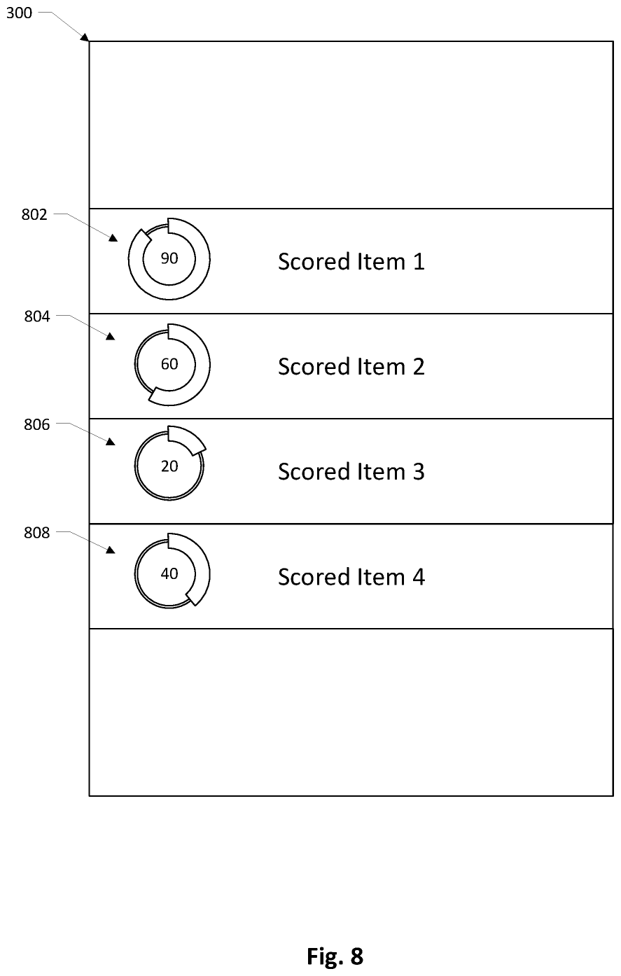

In some aspects of the present disclosure, more than one graphical interface 270 may be displayed on a display screen 300 at one time. This allows even more information to be compacted into a single display screen 300 that would otherwise require many screens and be difficult to absorb. FIG. 8 illustrates one such example of a display screen 300 displaying more than one graphical interface 270. The display screen 300 is shown displaying a graphical interface 802 for a first scored item, a graphical interface 804 for a second scored item, a graphical interface 806 for a third scored item, and a graphical interface 808 for a fourth scored item. In other examples, there may be more or less graphical interfaces 270 on a single display screen 300. As with the other examples described in connection with FIGS. 3A to 3D and 5A to 5D, a user may interact with any of the graphical interfaces 802, 804, 806, or 808 on the display screen 300. For example, a user may select (e.g., press, click, etc.) the OAS 222 of the graphical interface 802 to cause the display screen 300 to display the settings for that graphical interface 802 (e.g., the underlying subscores 240, 250, 260) or other information for the corresponding scored item (i.e., the first scored item).

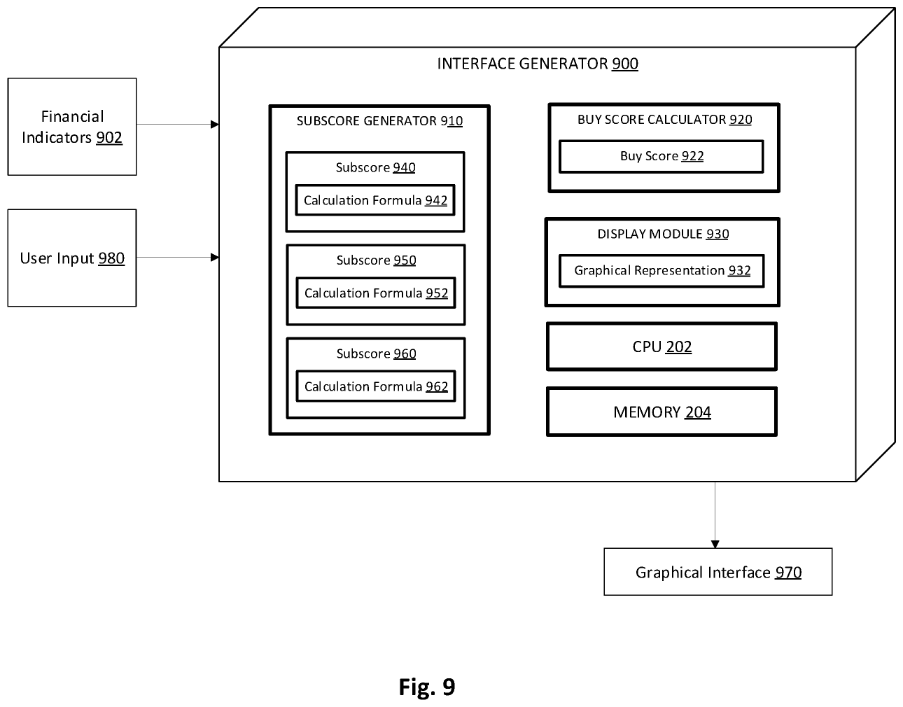

In one example of the present disclosure, a system is provided for generating and displaying graphical interfaces 270 for scoring financial assets for trading purposes. FIG. 9 shows an example interface generator 900 configured for generating a graphical interface 970, according to one aspect of the present disclosure. The interface generator 900 includes different components that are representative of computational processes, routines, and/or algorithms. In some embodiments, the computational processes, routines, and/or algorithms may be specified in one or more instructions stored on a computer readable medium that, when executed by a processor of the interface generator 900, cause the interface generator 900 to perform the operations discussed below. For example, all or part of the computational processes, routines, and/or algorithms may be implemented by the CPU 902 and the memory 904. It should be appreciated that in other embodiments the components of the interface generator 900 may be combined, rearranged, removed, or provided on a separate device or server.

The components of the interface generator 900 may correspond to the example components of the interface generator 104 previously described. For example, the subscore generator 910 operates like the subscore generator 210 and similarly generates subscores 940, 950, 960 from calculation formulas 942, 952, 962. The buy score calculator 920 calculates a buy score 922, which corresponds to the OAS calculator 220 that calculates an OAS 222. A buy score 922 is, however, a measure of the strength of a financial asset (e.g. security), for example, whether a user should buy or sell a particular financial asset. The display module 930 operates the same as the display module 230 and similarly generates a graphical representation 932 corresponding to a graphical representation 232. The interface generator 900 may also receive a user input 980 corresponding to a user input 200 and outputs a graphical interface 970 corresponding to a graphical interface 270.

The interface generator 900 particularly accesses or receives financial indicators 902 as the source data 102. Such financial indicators 902 may include any statistics used to measure current market conditions or to forecast financial or economic trends. Financial indicators 902 may include economic indicators, for example, statistical metrics used to measure the growth or contraction of the economy as a whole or sectors within the economy in order to provide insight into the future profitability potential of public companies. Financial indicators 902 may also include technical indicators used to predict changes in stock trends or price patterns in any traded asset, for example, a mathematical calculation based on a security's price and/or volume. For example, in some instances the financial indicators 902 may include the Moving Average Convergence-Divergence (MACD) indicator or the Relative Strength Index (RSI) indicator.

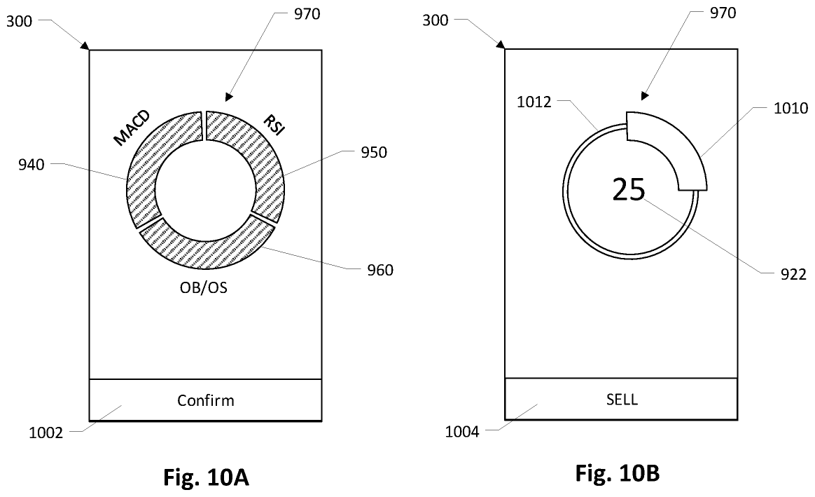

FIG. 10A shows an example display screen 300 displaying an example graphical interface 970 including graphical representations 932 for each of three subscores 940, 950, 960. In some instances, each of the subscores 940, 950, 960 may be based on a particular indicator from the financial indicators 902. For example, the subscore 940 may be based on a Moving Average Convergence Divergence (MACD) indicator, the subscore 950 may be based on a Relative Strength Index (RSI) indicator, and the subscore 960 may be based on an Overbought/Oversold (OB/OS) indicator. In other examples, the subscores 940, 950, 960 may be based on any other suitable financial indicator 902 as discussed above. In at least one example, each of the various subscores 940, 950, 960 may be assigned a weight and thus certain subscores 940, 950, 960 may have more of an impact on determining the buy score 922. For instance, each subscore 940, 950, 960 may be multiplied by a percentage out of “100” (e.g., 40%) to get a product and each product may be added together to get a sum. The sum may then be divided by “100” to get the buy score 922. In this instance, the percentages applied to the subscores 940, 950, 960 must add to “100”. In some aspects, a buy score 922 may start at “50” and its subscore 940, 950, 960 may cause the buy score 922 to increase or decrease according to the percentage each subscore 940, 950, 960 is set at.

In one example of the present disclosure, calculating a subscore 940, 950, 960 for a particular financial asset includes calculating a sum of a crossover score, a threshold score, and a strength score, all of which are determined by one or more selected financial indicators 902 for the particular financial asset. Each of the crossover score, the threshold score, and the strength score are assigned a percentage out of “100”, and the respective percentages add up to “100”. For example, the crossover score may be assigned 30%, the threshold score 20%, and the strength score 50%. For the crossover score, if a selected financial indicator 902 indicates a bullish crossover, then the crossover score equals the percentage assigned to the crossover score. If the selected financial indicator 902 indicates a bearish crossover, then the crossover score equals “0”. If the selected financial indicator 902 indicates neither a bullish nor a bearish crossover, then the crossover score equals half of the percentage assigned to the crossover score. For the threshold score, if the selected financial indicator 902 indicates that a bullish threshold has been breached, then the threshold score equals the percentage assigned to the threshold score. If the selected financial indicator 902 indicates that a bearish threshold has been breached, then the threshold score equals “0”. If the selected financial indicator 902 indicates that neither a bullish nor a bearish threshold has been breached, then the threshold score equals half of the percentage assigned to the threshold score.

For the strength score, a user may select more than one indicator and cause the presently disclosed system to combine the selected financial indicator 902 with a second indicator. For example, the presently disclosed system may combine the selected financial indicator 902 with a second financial indicator 902 to determine the strength score. In some aspects, a user may select a static value and the presently disclosed system may combine the selected financial indicator 902 with the static value. For example a static value may be a specific value of a selected financial indicator 902 that a user views as “strong” and the user desires the selected financial indicator 902 to be compared against it. If a user selects a second indicator in addition to the selected financial indicator 902, then a method is selected to cause the presently disclosed system to combine the two in at least the present example. For example, the combined financial indicator may be an average of, or difference between (e.g., subtraction), the selected financial indicator 902 and the second indicator. The combined financial indicator may alternatively be a regression model of the selected financial indicator 902 and the second indicator. The combined financial indicator may alternatively be a co-integration of the selected financial indicator 902 and the second indicator using the Dickey-Fuller test, or any other suitable method for combining the selected financial indicator 902 with another indicator. In other examples, the presently disclosed system may combine more than two indicators to generate the combined financial indicator.

In the present example, a strength may be calculated from either a single financial indicator 902 or from a combined financial indicator, and then a strength score may be calculated based on the strength. To calculate a strength, a financial indicator 902 or a combined financial indicator is viewed over a selected time period. In some aspects, a strength may be calculated using a scaled method. A scaled strength is calculated by Equation 1 below. The indicator value is the value of the financial indicator 902 or combined financial indicator at a given time, and the range is the difference between the maximum and minimum selected financial indicator 902 or combined financial indicator values over the selected time period.

$$\begin{matrix}Scaled Strength = \frac{( Indicator value - Min value )}{Range} \times 100 & Equation 1 \\ Z - Score Strength = \frac{x - μ}{σ} & Equation 2\end{matrix}$$

In other aspects, a strength may be calculated using a Z-score method. A Z-score strength is calculated by Equation 2 above, where x is the value of the selected financial indicator 902 or combined financial indicator at a given time, μ is the mean of the selected financial indicator 902 or combined financial indicator values over the selected time period, and a is the standard deviation of the values over the selected time period.

In the present example, if a rising strength score is selected as bullish, then a strength score is calculated as the product of the strength and the percentage assigned to the strength score, the product then being divided by “100”. If a falling strength score is selected as bullish, then the strength is instead multiplied by “−1” and added to “100”. The crossover score, threshold score, and strength score may then be added together to calculate their respective subscore 940, 950, 960.

FIG. 10B illustrates an example display screen 300 displaying the example graphical interface 970 showing a buy score 922 of “25” and its corresponding graphical representation 932. The graphical representation 932 includes an outer bar 1010 and an inner bar 1012 consistent with the description regarding the outer bar 310 and the inner bar 312. In the illustrated example, the display screen 300 does not include a settings button 306. Rather, as described above, a user may cause the display screen 300 to return to the display screen 300 in FIG. 10A by selecting the buy score 922 (e.g., by pressing or clicking it).

The illustrated example also shows the display screen 300 having a buy strength banner 1004. Similar to an OAS 222, in some aspects, a buy score 922 may have a “strength” such that a range between a first buy score 922 and a second buy score 922 may correspond to a “BUY” score indicating that a user should buy the financial asset (e.g., security). A different range may correspond to a “neutral” score indicating that a user could choose whether to buy or sell. And a different range may correspond to a “SELL” score indicating that a user should not buy the financial asset (e.g., security) or should sell it if the user owns it. For example, a buy score 922 of 75-100 may be a “BUY” score, of 26-74 may be a “neutral” score, and of 0-25 may be a “SELL” score. In other examples, the above ranges may be different or there may be additional ranges with other banner labels beyond buy, neutral, and sell. For example, there could be ranges for strong buy, buy, neutral, sell, and strong sell. In the illustrated example, the buy score 922 is “25” and thus the buy strength banner 1004 displays “SELL” to a user.

In some aspects of the present disclosure, a user may interact with the buy strength banner 1004. For example, selecting the buy strength banner 1004 (e.g., by pressing or clicking it) may cause a secondary system including, for example, an application or website, to execute a configured action. For instance, in the illustrated example of FIG. 10B, interacting with the buy strength banner 1004 may cause the secondary system to execute a sale at a financial institution of the user's financial asset (e.g., security) associated with the buy strength banner 1004 and the buy score 922. In other instances, interacting with the buy strength banner 1004 may cause the secondary system to execute a purchase or other trade of a financial asset associated with the respective buy strength banner 1004 and buy score 922.

As discussed above with regard to the score strength banner 304, the buy score 922 “strength” may, additionally or alternatively, be indicated by a color or pattern on the graphical representation 932 of the graphical interface 970, or by any other suitable indication on the display screen 300 instead of, or in addition to, the buy strength banner 1004. In some aspects of the present disclosure, the display screen 300 does not include any indication of a buy score 922 “strength” at all.

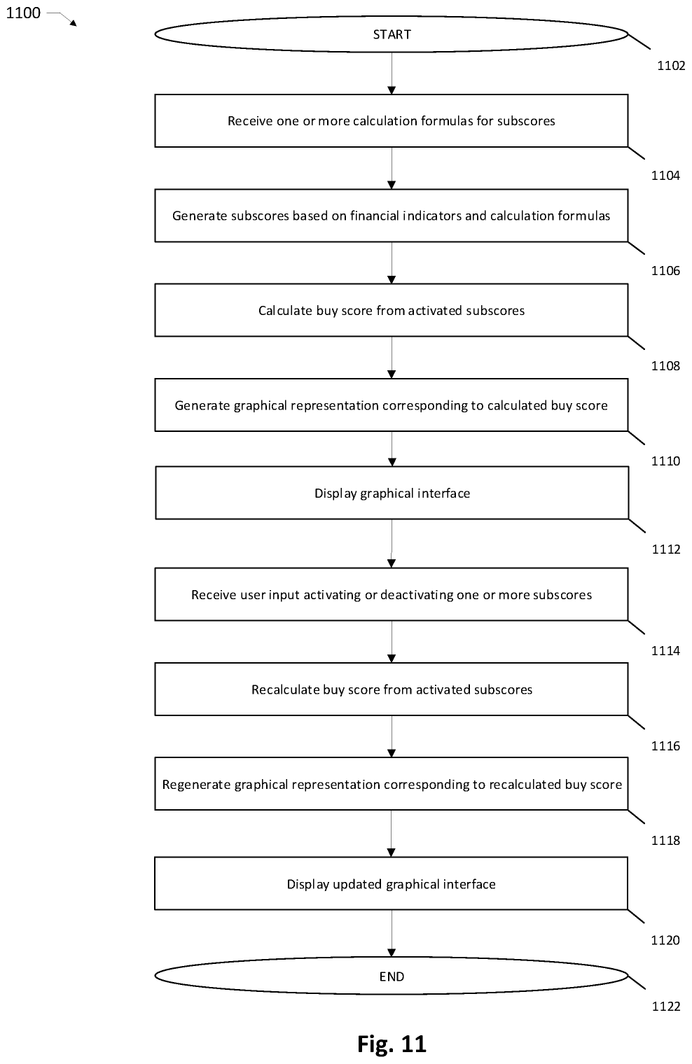

FIG. 11 shows an example method 1100 to display a graphical interface 970 that updates in response to activating or deactivating one or more subscores 940, 950, 960 according to an aspect of the present disclosure. The example method 1100 is similar to the example method 400. The method 1100 may be implemented on a computer system, such as the interface generator 904. For example, the method 1100 may be implemented by the subscore generator 910, the OAS calculator 920, and/or the display module 930 of the interface generator 900. The method 1100 may also be implemented by a set of instructions stored on a computer readable medium that, when executed by a processor, cause the computer system to perform the method. For example, all or part of the method 1100 may be implemented by the CPU 902 and the memory 904. Although the examples below are described with reference to the flowchart illustrated in FIG. 11, many other methods of performing the acts associated with FIG. 11 may be used. For example, the order of some of the blocks may be changed, certain blocks may be combined with other blocks, one or more of the blocks may be repeated, and some of the blocks described may be optional.

At 1102, the example method 1100 begins. At 1104, a system (e.g., the interface generator 900) receives various calculation methods (e.g., calculation formulas 942, 952, 962) for the various subscores (e.g., subscores 940, 950, 960). For example, a user may provide the calculation formulas 942, 952, 962 to the interface generator 900 from a device 108, 110, 112. In other examples, the system (e.g., the interface generator 9000 may use calculation methods (e.g., the calculation formulas 942, 952, 962) already stored in its memory (e.g., the memory 904) as described above in connection with the interface generator 104. In 1106, the system (e.g., the interface generator 900) may then access or receive data (e.g., the financial indicators 902) and the system (e.g., the subscore generator 910) may generate various subscores (e.g., subscores 940, 950, 960) based on their respective calculation methods (e.g., the calculation formulas 942, 952, 962) and the data (e.g., the financial indicators 902). In 1108, the system (e.g., the buy score calculator 920) may then calculate a score (e.g., a buy score 922) from the generated and activated subscores (e.g., subscores 940, 950, 960). In 1110 the system (e.g., the display module 930) may generate an image (e.g., a graphical representation 932) corresponding to the generated subscores (e.g., the subscores 940, 950, 960) and/or calculated score (e.g., the calculated buy score 922). At 1112, the system (e.g., the interface generator 900) may then cause the interface (e.g., the graphical interface 970) to be displayed on the screen (e.g., the display screen 300).

At 1114, the example method 1100 may then include the system (e.g., the interface generator 900) receiving an input (e.g., the user input 980) activating or deactivating one or more subscores (e.g., the subscores 940, 950, 960). In 1116, in response to such an input, the system (e.g., the buy score calculator 920) recalculates a new score (e.g., a new buy score 922) from the activated subscores (e.g., the subscores 940, 950, 960). In 1118, the system (e.g., the display module 930) may then regenerate a new image (e.g., a new graphical representation 932) corresponding to the newly recalculated score (e.g., the buy score 922). In 1120, the system (e.g., the interface generator 900) may then cause the updated interface (e.g., the updated graphical interface 970) to be displayed on the screen (e.g., the display screen 300). At 1122, the example method 1100 ends.

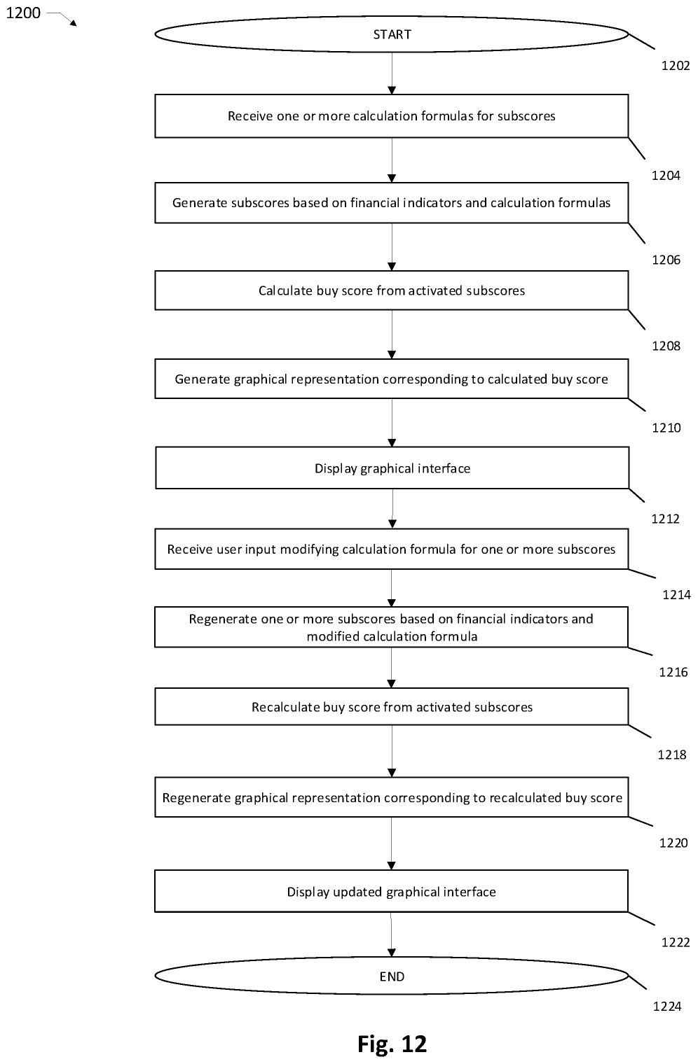

FIG. 12 shows an example method 1200 to display a graphical interface 270 that updates in response to modifying the calculation formulas 242, 252, 262 of one or more subscores 240, 250, 260 according to an aspect of the present disclosure. The example method 1200 is similar to the example method 600. The method 1200 may be implemented on a computer system, such as the interface generator 904. For example, the method 1200 may be implemented by the subscore generator 910, the OAS calculator 920, and/or the display module 930 of the interface generator 900. The method 1200 may also be implemented by a set of instructions stored on a computer readable medium that, when executed by a processor, cause the computer system to perform the method. For example, all or part of the method 1200 may be implemented by the CPU 902 and the memory 904. Although the examples below are described with reference to the flowchart illustrated in FIG. 12, many other methods of performing the acts associated with FIG. 12 may be used. For example, the order of some of the blocks may be changed, certain blocks may be combined with other blocks, one or more of the blocks may be repeated, and some of the blocks described may be optional.

At 1202, the example method 1200 begins. At 1204, a system (e.g., the interface generator 900) receives various calculation methods (e.g., calculation formulas 942, 952, 962) for the various subscores (e.g., subscores 940, 950, 960). For example, a user may provide the calculation formulas 942, 952, 962 to the interface generator 900 from a device 108, 110, 112. In other examples, the system (e.g., the interface generator 9000 may use calculation methods (e.g., the calculation formulas 942, 952, 962) already stored in its memory (e.g., the memory 904) as described above in connection with the interface generator 104. In 1206, the system (e.g., the interface generator 900) may then access or receive data (e.g., the financial indicators 902) and the system (e.g., the subscore generator 910) may generate various subscores (e.g., subscores 940, 950, 960) based on their respective calculation methods (e.g., the calculation formulas 942, 952, 962) and the data (e.g., the financial indicators 902). In 1208, the system (e.g., the buy score calculator 920) may then calculate a score (e.g., a buy score 922) from the generated and activated subscores (e.g., subscores 940, 950, 960). In 1210 the system (e.g., the display module 930) may generate an image (e.g., a graphical representation 932) corresponding to the generated subscores (e.g., the subscores 940, 950, 960) and/or calculated score (e.g., the calculated buy score 922). At 1212, the system (e.g., the interface generator 900) may then cause the interface (e.g., the graphical interface 970) to be displayed on the screen (e.g., the display screen 300).

At 1214, the example method 1200 may then include the system (e.g., the interface generator 900) receiving an input (e.g., the user input 980) modifying one or more calculation methods (e.g., the calculation formulas 942, 952, 962) of one or more subscores (e.g., the subscores 940, 950, 960. In 1216, in response to such an input, the system (e.g., the subscore generator 910) may regenerate one or more subscores (e.g., the subscores 940, 950, 960) based on the data (e.g., the financial indicators 902) and the one or more modified calculation methods (e.g., the modified calculation formulas 942, 952, 962). In some examples, the system (e.g., the subscore generator 910) may regenerate all of the subscores (e.g., the subscores 940, 950, 960) regardless of if their calculation method (e.g., their calculation formula 942, 952, 962) was modified. In other examples, the system (e.g., the subscore generator 910) may only regenerate a subscore (e.g., a subscore 942, 952, 962) if its calculation method (e.g., calculation formula 942, 952, 962) was modified. In 1218, the system (e.g., the buy score calculator 920) may then recalculate a new score (e.g., the buy score 922) from the activated subscores (e.g., the subscores 940, 950, 960). In 1220, the system (e.g., the display module 930) may then regenerate a new image (e.g., the graphical representation 932) corresponding to the newly recalculated score (e.g., the recalculated buy score 922). In 1222, the system (e.g., the interface generator 900) may then cause the updated interface (e.g., the updated graphical interface 970) to be displayed on the screen (e.g., the display screen 300. At 1224, the example method 1224 ends.

Without further elaboration, it is believed that one skilled in the art can use the preceding description to utilize the claimed inventions to their fullest extent. The examples and embodiments disclosed herein are to be construed as merely illustrative and not a limitation of the scope of the present disclosure in any way. It will be apparent to those having skill in the art that changes may be made to the details of the above-described embodiments without departing from the underlying principles discussed. In other words, various modifications and improvements of the embodiments specifically disclosed in the description above are within the scope of the appended claims. For example, any suitable combination of features of the various embodiments described is contemplated.

If a software function unit is realized and used as a product, it can be stored in a readable storage medium in a computer. Based on this understanding, the technical plan proposed by the present disclosure may be essentially or partially realized as a software product. In other cases, one or more parts of the above-described systems and methods that are beneficial to the conventional technology may be realized as the form of a software product. The software product may be stored in a storage medium, including one or more instructions for a computational device (such as a personal computer, a server, or a network device) to perform all or some of the steps disclosed by the embodiments of the present disclosure. The storage medium may include one or more media capable of storing program codes, such as one or more of a USB disk, a mobile hard disk, a read-only memory (ROM), a random-access memory (RAM), and a floppy disk.

The invention is claimed as follows:

1. A system comprising:
a processor;
a memory; and
a display screen, wherein the display screen is configured to:
display a graphical interface that includes a first overall aggregate score (OAS) and a graphical representation of the first OAS, wherein the first OAS is calculated based on a plurality of subscores, each of the subscores of the plurality of subscores calculated based on a corresponding summarization of source data;
upon interaction with the graphical interface, display a plurality of graphical representations of each of the plurality of subscores, wherein interacting with a first graphical representation of a first subscore at least one of activates and deactivates the first subscore;
responsive to one of activating and deactivating the first subscore, recalculate the first OAS and regenerate the graphical representation of the first OAS; and
update the displayed first OAS and the graphical representation of the first OAS with the recalculated first OAS and regenerated graphical representation of the recalculated first OAS.

2. The system of claim 1, wherein each corresponding summarization is generated with a same source data input using different respective calculation formulas.

3. The system of claim 1, wherein further interaction with the first graphical representation of the first subscore enables modifications to a first calculation formula of the first subscore.

4. The system of claim 3, wherein the display screen is further configured to, responsive to modifications to the first calculation formula of the first subscore, recalculate the first OAS and regenerate the graphical representation of the first OAS.

5. The system of claim 1, wherein the graphical representation of the first OAS is ring-shaped and revolved in proportion to the calculated first OAS.

6. The system of claim 1, wherein a second subscore of a different second OAS is imported as a subscore of the first OAS.

7. The system of claim 1, wherein a different second OAS is imported as a plurality of additional subscores of the first OAS.

8. The system of claim 1, wherein each subscore of the plurality of subscores is weighted individually as a component of the first OAS.

9. The system of claim 1, wherein the first OAS is normalized on a set numerical scale, and a color scheme of the graphical representation is configured to change based on a numerical value of the first OAS.

10. The system of claim 1, wherein the first subscore is calculated by combining a first indicator value and a second indicator value.

11. The system of claim 10, wherein the first indicator value is retrieved from the source data and the second indicator value is a static value.

12. The system of claim 10, wherein the first subscore is adjusted by a weighting factor based on a magnitude of difference between the first indicator value and the second indicator value.

13. The system of claim 1, wherein the source data is historical data from a selected historical time period.

14. The system of claim 1, wherein the source data is data receiving real-time updates.

15. The system of claim 1, wherein the display screen is installed in a portable computing device.

16. The system of claim 1, wherein a plurality of graphical interfaces are displayed concurrently on the display screen.

17. The system of claim 1, wherein the source data includes financial indicators related to valuing financial assets.

18. The system of claim 1, wherein interacting with the graphical interface triggers a secondary system to perform a configured action.

19. The system of claim 18, wherein the configured action includes executing a trade of a financial asset associated with the first OAS.

20. A method comprising:
causing a display screen to display a graphical interface that includes a first overall aggregate score (OAS) and a graphical representation of the first OAS, wherein the first OAS is calculated based on a plurality of subscores, each of the subscores of the plurality of subscores calculated based on a corresponding summarization of source data;
upon interaction with the graphical interface, causing the display screen to display a plurality of graphical representations of each of the plurality of subscores, wherein interacting with a first graphical representation of a first subscore at least one of activates and deactivates the first subscore;
in response to one of activating and deactivating the first subscore, causing the display screen to recalculate the first OAS and regenerate the graphical representation of the first OAS; and
causing the display screen to update the displayed first OAS and the graphical representation of the first OAS with the recalculated first OAS and regenerated graphical representation of the recalculated first OAS.
